(19) United States
(12) Patent Application Publication
(10) Pub. No.: US 2010/0177086 A1
(43) Pub. Date: Jul. 15, 2010

(54) IMAGE DISPLAY DEVICE

(75) Inventors: Norihiro Nakamura, Mobara (JP); Naoki Tokuda, Mobara (JP); Hajime Akimoto, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi Displays, Ltd.; Canon Kabushiki Kaisha

(21) Appl. No.: 12/685,765

(22) Filed: Jan. 12, 2010

(30) Foreign Application Priority Data
Jan. 13, 2009 (JP) 2009-004590

(51) Int. Cl. G09G 5/00; G09G 3/30

(52) U.S. Cl. 345/211; 345/76

(57) ABSTRACT

An image display device for displaying an image by causing a light emitting element contained in each of a plurality of pixels that are arranged in a display area (SA) to emit light includes: power supply paths for supplying electric power to each of a plurality of partial areas, which are created by dividing the display area (SA), independently of other partial areas to make the light emitting element of each pixel that belongs to the partial area emit light; and a power control unit for controlling electric power to be supplied from each of the power supply paths to the associated partial area, and at least some of the partial areas have an area that overlaps with other adjacent partial areas.

### CROSS-REFERENCE TO RELATED APPLICATION

The present application claims priority from Japanese application JP2009-004590 filed on Jan. 13, 2009, the content of which is hereby incorporated by reference into this application.

### BACKGROUND OF THE INVENTION

1. Field of the Invention

This invention relates to an image display device that performs display control of pixels by causing light emitting elements such as organic electroluminescence elements to emit light.

2. Description of the Related Art

Image display devices that display an image by controlling the luminance on a pixel basis include ones that perform display control of pixels by causing light emitting elements of the respective pixels to emit light, for example, organic electroluminescence display devices (hereinafter referred to as organic EL display devices) which include organic electroluminescence elements (hereinafter referred to as organic EL elements) as light emitting elements.

In those image display devices, a brighter screen (higher luminance) is generally desirable. Higher luminance, however, necessitates more power consumption, which goes against the request for reduction in power consumption. As a solution, techniques have been proposed which pay attention to the fact that what is important in terms of screen brightness to human sight is the luminance around the center of the screen (e.g., JP 06-282241 A and JP 2008-158399 A). One of the techniques improves the apparent brightness while preventing an increase in power consumption by enhancing the luminance in the central part of the screen. Another keeps power consumption low without sacrificing the apparent brightness by lowering the luminance along the edges of the screen.

In the above-mentioned image display devices that perform display control of pixels by causing light emitting elements to emit light, the ratio of power supplied for making the light emitting elements emit light to the overall power consumption of the device is large. The conventional techniques described above, which lower the luminance along the edges of the screen but allow pixels in the central part of the screen to emit high luminance light, are unable to lower the voltage applied to the light emitting elements of the respective pixels itself, and are unlikely to be helpful in keeping power consumption necessary to make light emitting elements emit light at a satisfactorily low level.

Also, light emitting elements of the respective pixels in the above-mentioned image display devices emit light at a brightness level that corresponds to the magnitude of current and/or voltage supplied from a power supply line. This means that fluctuations among pixels in terms of magnitude of power supplied from power supply lines may make the overall brightness of the display screen uneven. However, power supply from a power supply line is usually shared by a plurality of pixels. In addition, when to execute light emission control of pixels is common to a plurality of pixels, so that the light emission control is executed at once for the entire screen or executed on a pixel row basis. The consequence is that, when a plurality of pixels are to emit light simultaneously, a current flows from the same power supply line into a plurality of light emitting elements at once and the magnitude of power supplied to each pixel is accordingly reduced. Further, the resistance of the power supply line and other factors make the degree of this power reduction vary depending on how far along the power supply line a pixel in question is from the power source. The variation may cause a luminance gradient within the screen (luminance shading) in which each pixel has a brightness level that varies depending on the pixel's location in the screen.

### SUMMARY OF THE INVENTION

This invention has been made in view of the circumstances described above, and it is therefore an object of this invention to provide an image display device capable of controlling power that is supplied to each pixel to make a light emitting element emit light based on the pixel's location in a display area.

A representative aspect of the invention disclosed in this patent application is briefly summarized as follows.

(1) An image display device for displaying an image by causing a light emitting element contained in each of a plurality of pixels that are arranged in a display area to emit light, including: power supply paths for supplying electric power to each of a plurality of partial areas, which are created by dividing the display area, independently of other partial areas to make the light emitting element of each pixel that belongs to the partial area emit light; and a power control unit for controlling electric power to be supplied from each of the power supply paths to the associated partial area, in which at least some of the partial areas have an area that overlaps with other adjacent partial areas.

(2) The image display device according to item (1), in which the power control unit controls power that is supplied from each of the power supply paths to the associated partial area based on a location of the partial area.

(3) The image display device according to item (2), in which the power control unit controls power that is supplied from each of the power supply paths to the associated partial area based on a distance of the partial area from a center of the display area.

(4) The image display device according to item (1), in which the power control unit controls power that is supplied from each of the power supply paths to the associated partial area based on what image is to be displayed in the partial area.

(5) The image display device according to item (4), in which the power control unit controls power that is supplied from each of the power supply paths to the associated partial area based on an index value that indicates brightness of an image to be displayed in the partial area.

(6) The image display device according to item (1), in which at least some of the partial areas each include a plurality of small areas which are apart from one another within the display area.

(7) The image display device according to item (1), in which the light emitting element is an organic electroluminescence element, and the organic electroluminescence element emits light by allowing a current supplied from at least one of the power supply paths to flow into the organic electroluminescence element.

### BRIEF DESCRIPTION OF THE DRAWINGS

In the accompanying drawings:

FIG. 1 is a schematic diagram illustrating the exterior of an image display device according to a first embodiment of this invention;

FIG. 2 is a diagram illustrating the schematic structure of circuits that are formed on a glass substrate in the image display device according to the first embodiment of this invention;

FIG. 3 is a circuit diagram illustrating a structural example of a pixel circuit;

FIG. 4 is a sectional view illustrating an example of the sectional structure of a pixel;

FIG. 5 is a schematic plan view illustrating the schematic of a display area in the image display device according to the first embodiment of this invention;

FIG. 6 is a function block diagram illustrating an example of functions that the image display device according to the first embodiment of this invention has;

FIG. 7 is a flow chart illustrating an example of a control flow that is executed by the image display device according to the first embodiment of this invention;

FIG. 8 is a diagram of the display area;

FIG. 9A is a diagram illustrating an example of luminance distribution in a display screen;

FIG. 98 is a diagram illustrating the example of luminance distribution in the display screen;

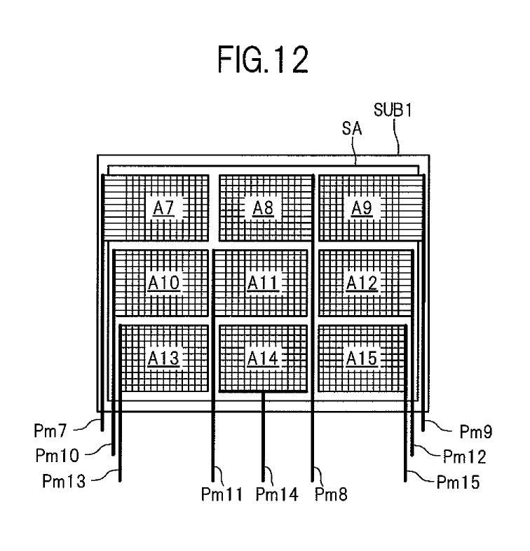

FIG. 10 is a schematic plan view illustrating the schematic of a display area in an image display device according to a second embodiment of this invention;

FIG. 11A is a diagram illustrating another example of luminance distribution in the display screen;

FIG. 11B is a diagram illustrating the other example of luminance distribution in the display screen; and

FIG. 12 is a schematic plan view illustrating the schematic of a display area in an image display device according to a third embodiment of this invention.

### DETAILED DESCRIPTION OF THE INVENTION

Hereinafter, embodiments of this invention are described in detail below with reference to the drawings. The following description takes as an example a case of applying this invention to an organic EL display device, which is one of modes of image display devices.

### First Embodiment

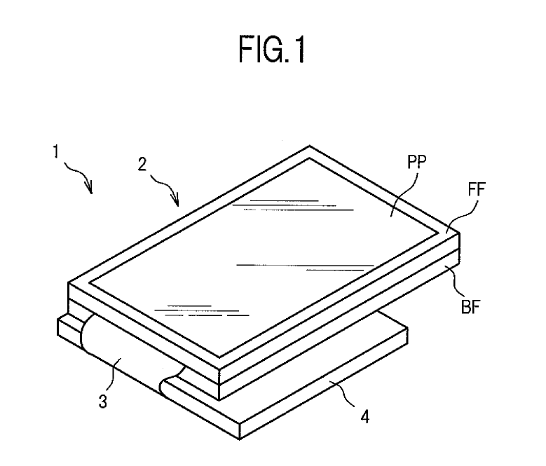

An image display device according to a first embodiment of this invention is described first. FIG. 1 is a schematic diagram illustrating the exterior of the image display device according to this embodiment. As illustrated in FIG. 1, the image display device according to this embodiment which is denoted by 1 includes a display panel 2, a flexible printed circuit board 3, and a rigid substrate 4. The display panel 2 contains a display area where an image is displayed. The flexible printed circuit board 3 is connected to the display panel 2. The rigid substrate 4 is connected to the flexible printed circuit board 3. The rigid substrate 4 may be fixed to the display panel 2 with, for example, an adhesive or double-sided tape, or may be fastened to a casing frame of the image display device 1 with a screw or the like.

The display panel 2 includes a glass substrate, a sealing substrate, a front frame FF, and a back frame BF. A plurality of pixel circuits each containing an organic EL element, which is a light emitting element, are formed in a matrix pattern on the glass substrate. The sealing substrate is bonded to the glass substrate to seal the organic EL element. The front frame FF frames the sealing substrate, leaving a part of the display panel 2 that serves as a display area open. The back frame BF frames the opposite side of the glass substrate and is fixed to the front frame FF by snap fit. A polarizing plate PP is bonded to the open part of the front frame FF which corresponds to the display area.

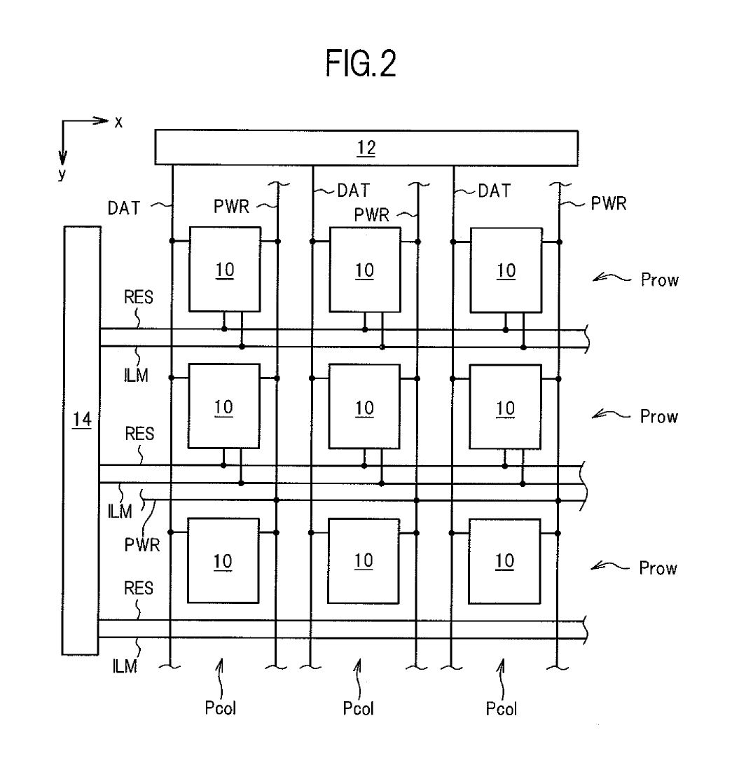

A thin film transistor (TFT) is formed on the glass substrate. The light emission of an organic EL element is controlled through the thin film transistor, to thereby perform display control on a pixel basis. FIG. 2 is a diagram illustrating an example of the schematic structure of pixel circuits that are mounted onto the glass substrate. As illustrated in FIG. 2, a plurality of pixel circuits 10 each containing a light emitting element are arranged in a matrix pattern within the display area of the image display device 1, and a data signal line DAT, a lighting switch control line ILM, a reset switch control line RES, and a power supply line PWR are connected to each of the pixel circuits 10. The data signal line DAT runs along the end-to-end direction of the display screen (the direction of a y axis in FIG. 2). A plurality of the data signal lines DAT are arranged in parallel to one another along the side-to-side direction of the display screen (the direction of an x axis in FIG. 2). The lighting switch control line ILM and the reset switch control line RES both run along the side-to-side direction of the display screen (the direction of the x axis in FIG. 2). A plurality of the lighting switch control lines ILM are arranged in parallel to one another along the end-to-end direction of the display screen (the direction of the y axis in FIG. 2), and a plurality of the reset switch control lines RES are arranged in the same manner. In short, a plurality of the pixel circuits 10 that are aligned in the x axis direction constitute one pixel row Prow, with one lighting switch control line ILM and one reset switch control line RES connected commonly to all the pixel circuits 10 that belong to the same pixel row Prow. A plurality of the pixel circuits 10 that are aligned in the y axis direction constitute one pixel column Pcol, with one data signal line DAT connected commonly to all the pixel circuits 10 that belong to the same pixel column Pcol.

As illustrated in FIG. 2, a plurality of the power supply lines PWR are arranged in a grid pattern in the display area. In other words, a plurality of the power supply lines PWR run in parallel to one another in the x axis direction and in the y axis direction each in FIG. 2. The power supply lines PWR running in the x axis direction and the power supply lines PWR running in the y axis direction are electrically connected to each other at their intersecting points. Power for driving light emitting elements in the respective pixel circuits 10 is supplied through the power supply lines PWR. Arranging the power supply lines PWR in a grid pattern in this manner reduces a drop in voltage supplied to each pixel through the power supply lines PWR which is caused by the electric resistance of the power supply lines PWR. The power supply lines PWR running in the x axis direction and the power supply lines PWR running in the y axis direction may be formed from the same material, or the material of the former may differ from that of the latter. The power supply lines PWR running in the x axis direction and the power supply lines PWR running in the y axis direction may each be arranged on a one-on-one basis with respect to the pixel rows or the pixel columns, or at an interval of a plurality of pixel rows or a plurality of pixel columns. In the example of FIG. 2, one power supply line PWR running in the y axis direction is placed for every pixel column and one power supply line PWR running in the x-axis direction is placed for every two pixel rows.

FIG. 2 illustrates only three rows by three columns of pixel circuits 10, that is, nine pixel circuits 10 in total, but actually, as many pixel circuits as the number of pixels constituting the display panel 2 are arranged in a matrix pattern on the glass substrate. For example, in the case of a display panel that has a resolution of 640 pixels (w)×480 pixels (h) such as the ones used in digital still cameras and the like, each pixel is constituted of three sub-pixels which respectively correspond to red (R), green (G), and blue (B) colors, and one pixel circuit 10 is formed for each sub-pixel. The total number of the pixel circuits 10 formed on the glass substrate is accordingly obtained as the product of 480 rows in the longitudinal direction and 640×3=1920 columns in the lateral direction (480×640×3 pixel circuits). In the following description, each sub-pixel constituted of one pixel circuit 10 is simply referred to as pixel.

Each data signal line DAT is connected at one end to a data signal output circuit 12, and each lighting switch control line ILM and each reset switch control line RES are connected at one end to a scanning circuit 14. The data signal output circuit 12 and the scanning circuit 14 may be formed from polycrystalline silicon TFT elements or the like on the glass substrate, as is the case for other components of the display panel 2 including a switch that is a constituent of each pixel circuit 10. Alternatively, the data signal output circuit 12 and the scanning circuit 14 may each be constituted of a single or a plurality of driver IC chips or the like mounted onto the glass substrate, or a combination of a driver IC chip and a circuit element such as a polycrystalline silicon TFT element. Each power supply line PWR is connected at one end to one of a plurality of main power supply lines Pm. In this embodiment, the plurality of main power supply lines Pm are arranged on the glass substrate to apply a voltage for making light emitting elements emit light to the respective pixels through the power supply lines PWR. The arrangement of the main power supply lines Pm is described later.

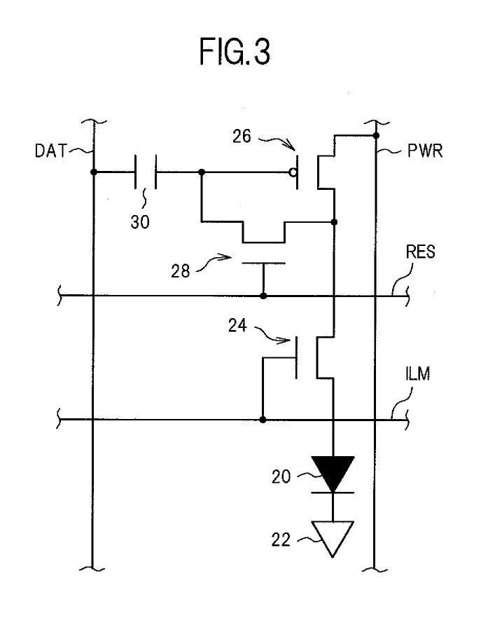

FIG. 3 is a circuit diagram illustrating a structural example of each pixel circuit 10. Each pixel circuit 10 is provided with an organic EL element 20 as a light emitting element, and a cathode end of the organic EL element 20 is connected to a common electrode 22. The common electrode 22 is an electrode set to a reference electric potential, which serves as the reference in the image display device 1. An anode end of the organic EL element 20 is connected to one end of a lighting switch 24, which is constituted of an n-type TFT. The other end of the lighting switch 24 is connected to the power supply line PWR via a driver TFT 26, which is a p-type TFT. When the driver TFT 26 and the lighting switch 24 are both turned on, a current flows from the power supply line PWR into the organic EL element 20 toward the common electrode 22, to thereby cause the organic EL element 20 to emit light.

A reset switch 28 constituted of an n-type TFT is connected between the other end of the lighting switch 24 and a gate of the driver TFT 26. One end of a storage capacitor 30 is also connected to the gate of the driver TFT 26. The other end of the storage capacitor 30 is connected to the data signal line DAT. As illustrated in FIG. 2, a gate of the lighting switch 24 is connected to the lighting switch control line ILM and a gate of the reset switch 28 is connected to the reset switch control line RES. Control signals having two voltage levels, VH (high voltage) and VL (low voltage), are input from these control lines ILM and RES to thereby switch the switches 24 and 28 on and off.

In the pixel circuit 10 of FIG. 3, the reset switch 28 and the lighting switch 24 are turned on first to reset luminance information that has been set to the pixel. A signal having a voltage level that reflects luminance information about a luminance at which this pixel is to emit light is then input through the data signal line DAT, and the information is held in the storage capacitor 30. Thereafter, the lighting switch 24 is turned on and a light emission period control signal is simultaneously input through the data signal line DAT, causing the organic EL element 20 to emit light only for a period in which the light emission period control signal is lower than a threshold that is set in accordance with the luminance information. The light emission period control signal is a triangular wave or the like whose voltage level goes up and down with time. In this way, the length of a light emission period is changed in accordance with the luminance information written in advance, and the luminance of each pixel is controlled by how long the light emission period is. In this embodiment, while luminance information is written on a pixel row basis, the light emission period control signal is input to all pixels in the display screen at once. Consequently, the pixels all emit light at the same timing in one frame period.

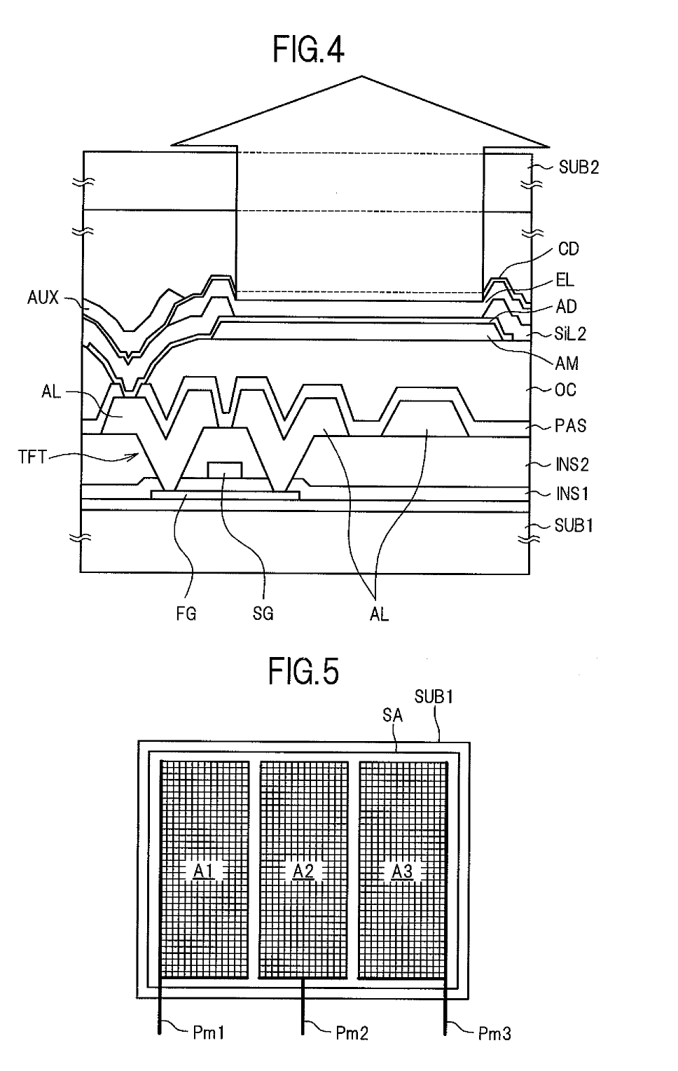

FIG. 4 is a sectional view illustrating an example of the sectional structure of the display panel 2 in the image display device 1. The example of FIG. 4 illustrates the sectional structure of a part containing the organic EL element 20 that is a constituent of one pixel and a TFT that is connected to this organic EL element 20. The upward arrow in FIG. 4 points a direction in which light is emitted.

In manufacturing the display panel 2, the first step is a low temperature polycrystalline silicon (LTPS) step where, as illustrated in FIG. 4, the TFT is formed by sequentially layering on a glass substrate SUB1 a channel layer FG, which is made of polycrystalline silicon, a gate insulating film INS1, which is made of plasma-enhanced tetraethoxysilane (P-TEOS), a gate wiring line SG, which is made of molybdenum-tungsten (MoW), a CONT insulating film INS2, which is made of P-TEOS, a source/drain wiring line AL, which is formed from a metal material, and a passivation layer PAS, which is made of plasma-deposited silicon nitride (P—SiN). Thereafter, a leveling layer OC is formed on the passivation layer PAS to level steps that have been created as a result of forming the TFT. The leveling layer OC may be an inorganic film such as a silicon nitride film or may be an organic film such as an acrylic resin film or a polyimide resin film. A reflective layer AM is formed next on the leveling layer OC. The reflective layer AM has a two-layer structure of, for example, a MoW (Mo: 80 wt %, W: 20 wt %) layer and an aluminum/silicon (AlSi) (Si: 1.0 wt % or less) layer. An anode AD is subsequently formed from indium tin oxide (ITO). The anode AD is connected to the source/drain wiring line AL. Thereafter, a silicon nitride (SiN) bank SiL2 for preventing a short circuit between the anode and a cathode at an end of the electrode is formed as the final step of the LTPS step.

The next step is an organic light emitting diode (OLED) step in which a detailed mask for separating R, G, and B from one another is used to form an organic EL layer, and a transparent cathode CD is formed from indium-zinc oxide (IZO) so as to cover the entire display area. The transparent cathode CD needs to be thinned into a thin film. For that reason, an auxiliary electrode AUX is further formed in order to reduce the resistance between adjacent pixels. Lastly, a sealing substrate SUB2 to which a drying agent has been applied to prevent the permeation of moisture is used to seal the display panel in an N₂ environment, whereby the manufacture of the display panel is completed.

The description of the sectional structure given here assumes that the image display device 1 is a top emission organic EL display device. However, the image display device 1 is not limited thereto and may be a bottom emission organic EL display device.

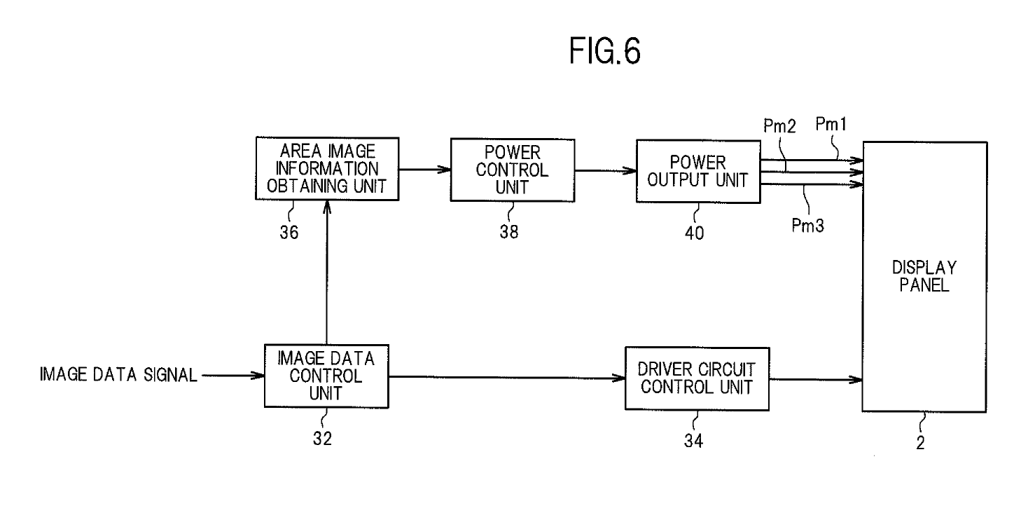

FIG. 5 is a schematic plan view illustrating the schematic of a display area SA, which is formed on the glass substrate SUB1 by arranging the pixel circuits 10 described above in a matrix pattern. As illustrated in FIG. 5, the display area SA in this embodiment is divided into three partial areas A1 to A3. To elaborate, the display area SA is divided into three along the end-to-end direction (y axis direction) so that pixels belonging to the same pixel column Pcol are contained in the same partial area.

Power for making light emitting elements of the respective pixels emit light is supplied to the partial areas A1, A2, and A3 independently of one another. Specifically, the power supply lines PWR in the partial area A1 are connected to a main power supply line Pm1, and power is supplied to pixels in the partial area A1 through the main power supply line Pm1. Power supply to pixels in the partial area A2 and power supply to pixels in the partial area A3 are executed through a main power supply line Pm2 and a main power supply line Pm3, respectively. The main power supply lines Pm1, Pm2, and Pm3 are power supply routes independent of one another. This way, the entire screen is fairly well protected against a luminance gradient within the screen.

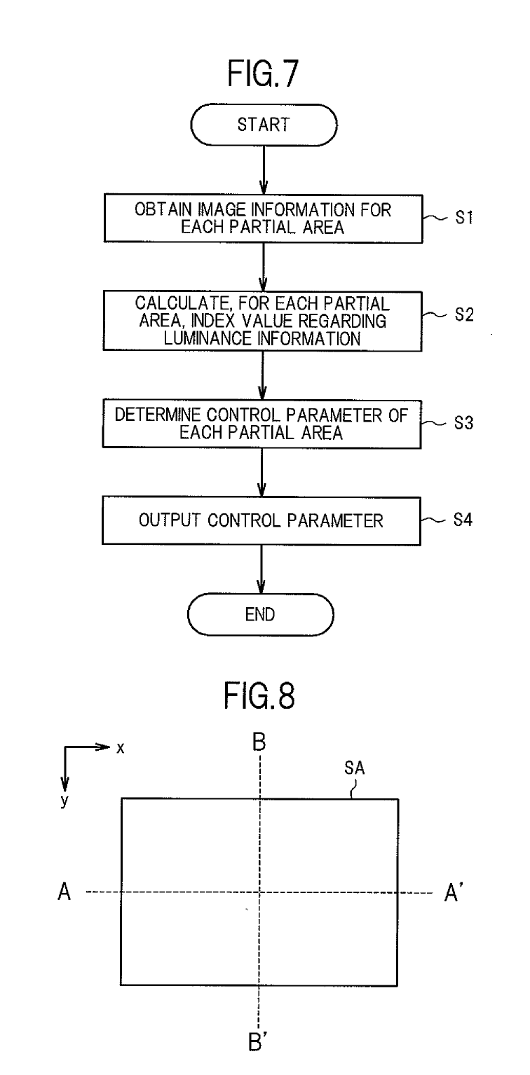

Further, in this embodiment, power supplied from the main power supply lines Pm1, Pm2, and Pm3 to their associated partial areas is controlled independently of one another. The magnitude of power supplied to the partial areas A1 to A3 may therefore be set differently from one another. FIG. 6 is a function block diagram illustrating an example of functions that the image display device 1 according to this embodiment has in order to accomplish this control. As illustrated in FIG. 6, the image display device 1 includes an image data control unit 32, a driver circuit control unit 34, an area image information obtaining unit 36, a power control unit 38, and a power output unit 40. These functions may be implemented by, for example, executing a program that is stored in a given storage area in advance with a microprocessor or the like that is mounted to the flexible printed circuit board 3 or the rigid substrate 4. Some of these functions may be implemented by a digital circuit, an analog circuit, or the like.

The image data control unit 32 receives an input of an image data signal from the outside, and executes image processing for displaying the received image data on the display panel 2. The driver circuit control unit 34 receives, frame by frame, signals that are related to image data output from the image data control unit 32, and supplies luminance information of each pixel which reflects the image data to the data signal output circuit 12 in the display panel 2.

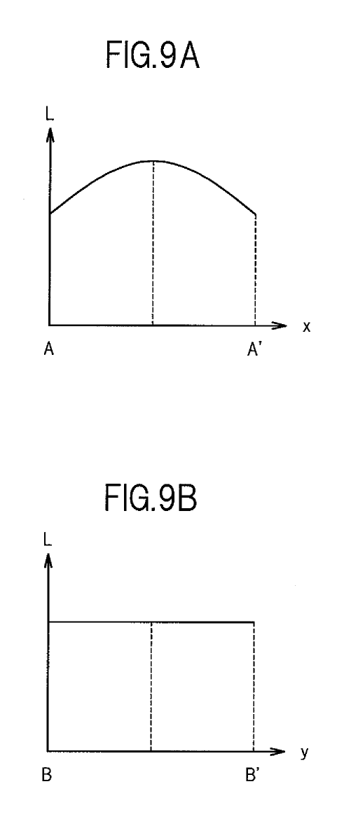

The area image information obtaining unit 36 and the power control unit 38 use information about image data output from the image data control unit 32 to control power supplied from the power output unit 40 to the display panel 2. FIG. 7 is a flow chart illustrating a concrete example of this control.

In the example of FIG. 7, the area image information obtaining unit 36 receives from the image data control unit 32 a signal related to image data, and obtains for each partial area illustrated in FIG. 6 information about an image that is contained in the partial area (step S1). The power control unit 38 uses the partial area-based information about the image which has been obtained in the step S1 to calculate for each partial area an index value regarding pixel luminance information (step S2). The index value may be a value about how bright an image the associated partial area is to display, for example, the number of pixels in the partial area that are to emit light at a luminance equal to or higher than a given threshold, or the sum of the luminance values of the pixels.

Based on the index value calculated in the step S2, the power control unit 38 determines for each partial area a control parameter that corresponds to the value of a power supply voltage to be output (step S3). The control parameter is expressed by, for example, a 6-bit value from 0 to 63, each of which is associated with a power supply voltage value from 5.00 V to 10.0 V. To elaborate, each control parameter value is associated with one of power supply voltage values spaced at an interval of 0.08 V, so that control parameter values “0” and “1” are associated with 5.00 V and 5.08 V, respectively. The power control unit 38 outputs the control parameter determined in the step S3 to the power output unit 40 (step S4).

The power output unit 40 includes a power supply circuit and other components to output power supplied from a power source (a battery or the like) to the main power supply lines Pm1, Pm2, and Pm3 separately. The power output unit 40 controls power that is supplied to the main power supply lines Pm1, Pm2, and Pm3 separately based on the values of the control parameters, which are output from the power control unit 38 in the step S4 described above. Specifically, the power output unit 40 here varies the voltage to be applied to each main power supply line Pm to match one of the voltage values from 5.00 V to 10.0 V that is associated with the control parameter value calculated for each partial area. This way, power may be supplied to the partial areas A1 to A3 at different voltages from one another. Also, the voltage applied to each partial area is varied here depending on the index value which is related to an image to be displayed in the partial area, such as the number of pixels in the partial area that emit light or the light emission amount in the partial area. This way, power may be supplied at a high voltage to a partial area that is expected to be affected more by a drop in voltage, and the influence of a luminance gradient within the screen is thus lessened.

In the above description, power supplied to each partial area is controlled in accordance with input image data. However, the image display device 1 is not limited thereto and the magnitude of power supplied to each partial area may be controlled based on the location of the partial area in the display area SA. For example, the power control unit 38 may control the power output unit 40 such that a larger power is supplied to a partial area that is closer to the center of the display area SA whereas a smaller power is supplied to a partial area that is further from the center of the display area SA.

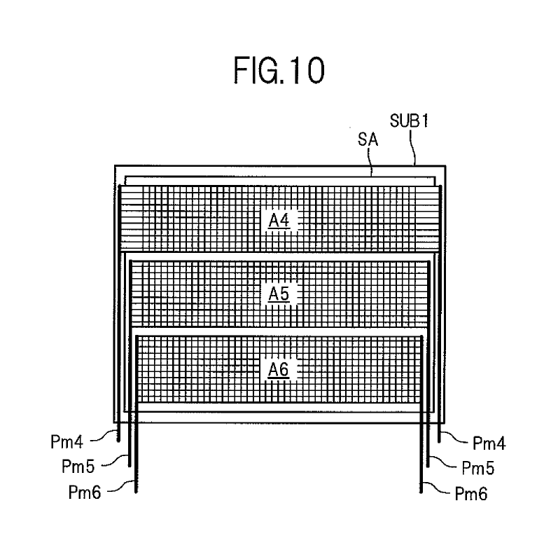

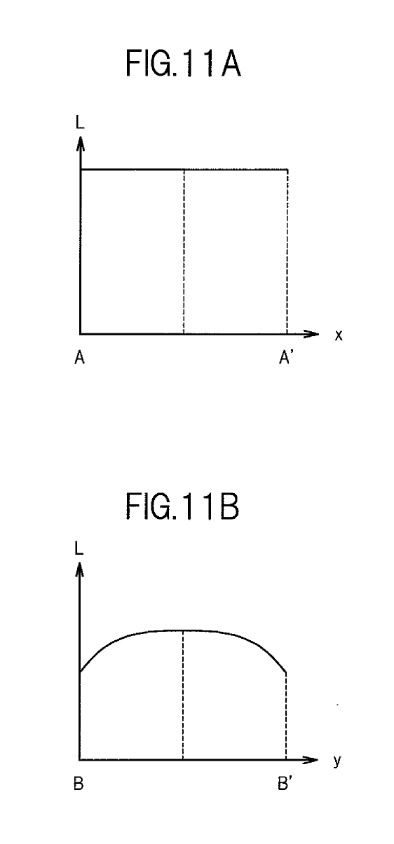

To give a concrete example, the power output unit 40 may output a higher voltage to the main power supply line Pm2, which is associated with the partial area A2, than voltages output to the other main power supply lines Pm1 and Pm3, and output lower voltages to the main power supply lines Pm1 and Pm3, which are associated with the partial areas A1 and A3, respectively, than the one output to the main power supply line Pm2. FIGS. 8, 9A, and 9B are diagrams for describing the luminance in the display screen in this case. FIG. 8 illustrates positions of lines A-A′ and B-B′ in the display area SA. FIG. 9A illustrates the pixel luminance distribution along the line A-A′ when all pixels within the display area SA are lit at the maximum luminance (100%). Similarly, FIG. 9B illustrates the pixel luminance distribution along the line B-B′. A vertical axis L in FIGS. 9A and 9B illustrates the luminance. In the example of these figures, the luminance is high around a center line indicating the center in the x axis direction of the display area SA, and is relatively low at locations close to the left and right edges of the screen. This way, power consumption may be reduced by lowering the voltages that are output to the main power supply lines Pm1 and Pm3 without lowering the luminance in the partial area A2, which is around the center of the screen where a viewer's attention tends to be focused.

### Second Embodiment

An image display device according to a second embodiment of this invention is described next. The following description focuses on differences from the first embodiment while omitting a description on the structure and functions of the image display device according to this embodiment that are similar to those of the image display device according to the first embodiment. Components similar to those in the first embodiment are referred to by the same reference symbols.

This embodiment differs from the first embodiment in the arrangement of the partial areas within the display area SA and the arrangement of the main power supply lines Pm which corresponds to the arrangement of the partial areas. FIG. 10 is a schematic plan view illustrating how the partial areas are arranged in the display area SA in this embodiment. As illustrated in FIG. 10, the display area SA in this embodiment is divided into three partial areas, A4 to A6. Unlike the example of FIG. 5 according to the first embodiment, the display area SA here is divided into three along the side-to-side direction (x axis direction) so that pixels belonging to the same pixel row Prow are contained in the same partial area.

Also, each partial area in this embodiment receives power supply from a plurality of main power supply lines Pm. Specifically, power to pixels in the partial area A4 is supplied from two main power supply lines Pm4, power to pixels in the partial area A5 is supplied from two main power supply lines Pm5, and power to pixels in the partial area A6 is supplied from two main power supply lines Pm6.

The magnitude of power supplied through these main power supply lines Pm may be controlled based on what image is to be displayed in the associated partial area as in the example described in the first embodiment. Alternatively, the magnitude of power supplied to each partial area may be controlled based on the location of the partial area in the display area SA.

FIGS. 11A and 11B are diagrams illustrating an example of luminance distribution that is observed when the partial area arrangement of this embodiment illustrated in FIG. 10 is employed and the output voltage is controlled based on the location of the partial area in question. Similarly to FIGS. 9A and 9B, FIGS. 11A and 11B illustrate pixel luminance distribution along the lines A-A′ and B-B′ of FIG. 8. In FIGS. 11A and 11B, the power output unit 40 outputs a higher voltage to the main power supply lines Pm5, which are associated with the partial area A5 containing the center of the display area SA, than voltages output to the other main power supply lines Pm4 and Pm6, and outputs lower voltages to the main power supply lines Pm4 and Pm6, which are associated with the partial areas A4 and A6, respectively, than the voltage output to the main power supply lines Pm5. The luminance in this case is high around a center line indicating the center in the y axis direction of the display area SA, and is relatively low at locations close to the top and bottom edges of the screen as illustrated in FIGS. 11A and 11B. This way, as in the example of FIGS. 9A and 9B, power consumption may be reduced by lowering the voltages that are output to the main power supply lines Pm4 and Pm6 without lowering the luminance in the partial area A5, which is around the center of the screen where a viewer's attention tends to be focused.

### Third Embodiment

An image display device according to a third embodiment of this invention is described next. The image display device according to this embodiment has the same structure as that of the image display devices according to the other embodiments, except for the arrangement of the partial areas within the display area SA and the arrangement of the main power supply lines Pm which corresponds to the arrangement of the partial areas.

FIG. 12 is a schematic plan view illustrating how the partial areas are arranged in the display area SA in this embodiment. As illustrated in FIG. 12, the display area SA in this embodiment is divided longitudinally into three and laterally into three, nine partial areas in total which are denoted by A7 to A15. Power is supplied to pixels contained in the respective partial areas A7 to A15 through main power supply lines Pm7 to Pm15, which are independent of one another.

The magnitude of power supplied through these main power supply lines Pm may be controlled based on what image is to be displayed in the associated partial area as in the examples described in the first and second embodiments. Alternatively, the magnitude of power supplied to each partial area may be controlled based on the location of the partial area in the display area SA.

To give a concrete example, the image display device according to this embodiment may output a relatively high voltage to the main power supply line Pm11, which is associated with the partial area All containing the center of the display area SA, in relation to voltages output to the other main power supply lines Pm. Voltages output to the main power supply lines Pm7, Pm9, Pm13, and Pm15, which are respectively associated with the partial areas A7, A9, A13, and A15 whose median points are apart from the center of the display area SA, may be set lower than voltages output to the main power supply lines Pm8, Pm10, Pm12, and Pm14, which are respectively associated with the partial areas A8, A10, A12, and A14 relatively close to the center of the display area SA. Pixel luminance distribution that is observed in this case along the lines A-A′ and B-B′ of FIG. 8 is similar to those illustrated in FIG. 9A and FIG. 11B, respectively. This way, power consumption may be reduced by lowering the voltages that are output to other main power supply lines Pm than Pm11 without lowering the luminance in the partial area A11, which is around the center of the screen where a viewer's attention tends to be focused.

Unlike the other embodiments described above, one of the partial areas in this embodiment (specifically, the partial area A11) are not in contact with the perimeter of the display area SA. This makes it impossible to supply power to every partial area solely with the main power supply lines Pm arranged along the perimeter of the display area SA, and the main power supply line Pm11 for supplying power to the partial area A11 needs to be arranged so as to run through other partial areas. In this case, too, the main power supply lines Pm may be arranged within the display area SA in a manner that avoids interference with the pixel circuits 10 in the other partial areas by forming the main power supply lines Pm in a layer between the layer where the pixel circuits 10 are formed and the glass substrate SUB1, for example, immediately above the glass substrate SUB1 in the sectional view of FIG. 4.

The image display devices according to the embodiments of this invention described above may control power supplied to each pixel to make a light emitting element emit light based on the location of the pixel in the display area. Thus, a luminance gradient within the screen in which the luminance is varied depending on the location in the screen may be reduced, and power necessary to make light emitting elements in the respective pixels emit light may be kept low without lowering the apparent luminance sensed by a viewer.

The image display devices according to the embodiments of this invention may be employed as display devices for displaying various types of information, such as displays for personal computers, displays for receiving TV broadcasting, and displays for displaying advertisements. The image display devices according to the embodiments of this invention may also be used as display parts of various electronic devices such as digital still cameras, video cameras, car navigation systems, car audio systems, game machines, and portable information terminals.

### Modification Example

A few modification examples of the image display devices according to the embodiments of this invention are described below.

First, in the image display devices according to the embodiments of this invention, one partial area to which power is supplied independently of other partial areas may be constituted of a plurality of small areas which are apart from one another. To give a concrete example, the display area SA may be divided into a plurality of small areas along the x axis direction or the y axis direction, so that power to a first partial area constituted of two or more small areas that are picked alternately out of the plurality of small areas is supplied from a first main power supply line Pm, whereas power to a second partial area constituted of the rest of the small areas is supplied from a second main power supply line Pm. In this case, too, power may be supplied to each of a plurality of partial areas of the display area SA independently of one another, and the influence of a luminance gradient within the screen which is caused when pixels in the display area SA are lit at once may thus be reduced. In addition, with each partial area constituted of small areas that are dispersed throughout the screen in this manner, when pixels that are to emit light concentrate in a specific region of the display area SA, for example, this region is highly likely to stretch over a plurality of partial areas, and reducing the influence of a luminance gradient within the screen is accordingly facilitated.

At least some of the partial areas may be arranged so as to contain an area where the partial area overlaps with other adjacent partial areas. In this case, the area overlapping with other partial areas has a mixture of pixels that receive power supply from different main power supply lines Pm from one another, such as pixels of staggered pixel rows Prow or pixel columns Pcol that receive power supply from the main power supply lines Pm independent of one another. This way, a phenomenon in which pixels that are intended to emit light at the same luminance emit light at different luminance near the border between adjacent partial areas is reduced, and the border between partial areas is made inconspicuous.

The power control unit 38, which controls the magnitude of power supplied to each main power supply line Pm, may control power supply based on other conditions than the location of the associated partial area and information about an image to be displayed in the associated partial area. For instance, the power control unit 38 may vary the magnitude of power supplied to each main power supply line Pm depending on the external environment of the image display device 1 (e.g., the brightness of ambient light). To give a concrete example, the power control unit 38 regularly obtains information about the brightness of ambient light from an output of a photo sensor or the like and chooses one out of a plurality of display modes in accordance with the obtained information. The power control unit 38 then changes the magnitude of power supplied to each main power supply line Pm such that the overall brightness of the display screen suits the chosen display mode. In changing the supplied power, the power control unit 38 may uniformly change power supplied to all the main power supply lines Pm, or may individually change power supplied to each main power supply line Pm, in accordance with the obtained information. For example, power may be supplied to a plurality of partial areas at different voltage values from one another based on the respective outputs of a plurality of photo sensors, which are placed in different directions from one another in relation to the display screen.

The power control unit 38 may also vary power supplied to each main power supply line Pm depending on what application contents are to be displayed. Specifically, power supplied when a menu window is to be displayed and power supplied when a photographic image is to be displayed may be set differently from each other. The power control unit 38 in this case obtains, for example, information about the type of the image to be displayed from the image data control unit 32, and controls supplied power in accordance with the obtained information.

The power control unit 38 may also vary power supplied to each main power supply line Pm depending on the continuous operation time or what image has been displayed in the past. To give a concrete example, when a partial area undergoes little change for a given period of time in terms of what image is displayed, the power control unit 38 performs control that reduces power supplied to this partial area. The power control unit 38 accomplishes this control by, for example, calculating, for each partial area, for every given period of time, statistics information about what image is displayed. When the statistics information indicates a change equal to or larger than a given threshold from the last time the calculation is made, the power control unit 38 determines that the image has changed and writes information that indicates the timing of the change (e.g., time information) in a given area of a memory. The information indicating the timing is regularly referred to in order to determine whether or not a given period of time has elapsed since the specifics of the image displayed in each partial area have changed last. When the same image is kept displayed in a given partial area within the display screen, for example, when a menu is displayed, controlling power supply in this manner is effective in preventing burn-in in the partial area without lowering the luminance of other areas by reducing only power that is supplied to this partial area.

The various conditions described above as conditions used by the power control unit 38 to determine how much power is to be supplied to each main power supply line Pm may be used in combination. For instance, the power control unit 38 may vary the voltage applied to each main power supply line Pm based on a control parameter that is calculated by adding evaluation values determined by different conditions. The power control unit 38 may also execute power control based on the location of each partial area in the display area SA (e.g., control that enhances the luminance in a partial area around the center of the screen) when the brightness of ambient light is equal to or more than a given threshold, while setting the entire screen to a uniform light emission luminance instead of executing this control when the brightness of ambient light is less than the given threshold.

In the above description, an organic EL element is used as a light emitting element. However, the image display devices according to the embodiments of this invention are not limited thereto and may use various light emitting elements whose luminance is varied depending on the input current or voltage, for example, inorganic EL elements and field emission devices (FEDs). Also, the structure of the pixel circuits and the light emission control method of the pixels are not limited to those described above, and other structures and methods may be employed.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image display device for displaying an image by causing a light emitting element contained in each of a plurality of pixels that are arranged in a display area to emit light, comprising:
power supply paths for supplying electric power to each of a plurality of partial areas, which are created by dividing the display area, independently of other partial areas to make the light emitting element of each pixel that belongs to the partial area emit light; and
a power control unit for controlling electric power to be supplied from each of the power supply paths to the associated partial area,
wherein at least some of the partial areas have an area that overlaps with other adjacent partial areas.

2. The image display device according to claim 1, wherein the power control unit controls power that is supplied from each of the power supply paths to the associated partial area based on a location of the partial area.

3. The image display device according to claim 2, wherein the power control unit controls power that is supplied from each of the power supply paths to the associated partial area based on a distance of the partial area from a center of the display area.

4. The image display device according to claim 1, wherein the power control unit controls power that is supplied from each of the power supply paths to the associated partial area based on what image is to be displayed in the partial area.

5. The image display device according to claim 4, wherein the power control unit controls power that is supplied from each of the power supply paths to the associated partial area based on an index value that indicates brightness of an image to be displayed in the partial area.

6. The image display device according to claim 1, wherein at least some of the partial areas each include a plurality of small areas which are apart from one another within the display area.

7. The image display device according to claim 1,
wherein the light emitting element comprises an organic electroluminescence element, and
wherein the organic electroluminescence element emits light by allowing a current supplied from at least one of the power supply paths to flow into the organic electroluminescence element.
